(19) United States
(12) Patent Application Publication
(10) Pub. No.: US 2006/0166074 A1
(43) Pub. Date: Jul. 27, 2006

(54) Fuel cell electrode assembly

(76) Inventors: Alfred I-Tsung Pan, Sunnyvale, CA (US); Yoocharn Jeon, Palo Alto, CA (US); Laurie S. Mittelstadt, Belmont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/043,249

(22) Filed: Jan. 26, 2005

(51) Int. Cl. H01M 4/94; H01M 4/96; H01M 4/88

(52) U.S. Cl. 429/42; 429/44; 502/101

(57) ABSTRACT

A fuel cell electrode assembly includes an electrolyte, a porous diffusion layer, and a catalyst layer interposed between the electrolyte and the diffusion layer. The catalyst layer includes a mixture of one or more catalysts supported by a conducting high surface area structure(s), one or more polymeric electrolytes, and a plurality of fibers. The plurality of fibers each has an average diameter greater than about 100 nm.

### BACKGROUND

Fuel cells utilize an electrochemical energy conversion of fuel (including but not limited to hydrogen, propane, methane, carbon monoxide, and the like) and oxidant(s) to produce electricity and heat. It is anticipated that fuel cells may be able to replace primary and secondary batteries as a portable (or non-portable) power supply. In fuel cells, the fuel (usually containing a source of hydrogen) is oxidized typically with a source of oxygen to produce (primarily) water and carbon dioxide. The oxidation reaction at the anode, which liberates electrons, in combination with the reduction reaction at the cathode, which consumes electrons, results in a useful electrical voltage and current through the load.

As such, fuel cells provide a direct current (DC) voltage that may be used to power motors, lights, electrical appliances, etc. A direct methanol fuel cell (DMFC) is one type of fuel cell that may be useful in portable or non-portable applications. In one DMFC, an electrode made up of catalyst and polymeric electrolyte may be sandwiched between a diffusion layer and an electrolyte. However, upon heating, the electrode may, in some instances, crack. The cracking of the electrode may be due in part to a volume reduction when solvents (e.g. water, isopropanol, etc.) evaporate from the electrode. Cracking may result in a loss of adhesion between the electrolyte and the diffusion layer. Further, cracking may, in some instances, increase the electrical resistance within the catalyst layer and between the catalyst and the diffusion layer.

As such, it would be desirable to provide a direct methanol fuel cell that substantially resists cracking during heating and drying processes.

### SUMMARY

A fuel cell electrode assembly including an electrolyte, a porous diffusion layer, and a catalyst layer interposed between the electrolyte and the diffusion layer is disclosed. The catalyst layer includes a mixture of one or more catalysts supported by a conducting high surface area structure(s), one or more polymeric electrolytes, and a plurality of fibers. The plurality of fibers each has an average diameter greater than about 100 nm.

### BRIEF DESCRIPTION OF THE DRAWINGS

Objects, features and advantages will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1 is a flow diagram depicting an embodiment of the method;

FIG. 2 is a semi-schematic view of an embodiment of a fuel cell electrode assembly;

FIG. 3 is an enlarged semi-schematic view of an embodiment of a catalyst layer; and

FIG. 4 is a schematic view of an embodiment of a fuel cell.

### DETAILED DESCRIPTION

Embodiment(s) of the present disclosure provide a fuel cell electrode assembly for use in a fuel cell, non-limitative examples of which include Direct Methanol Fuel Cells (DMFC), Polymer Electrolyte Membrane (PEM) fuel cells, and solid acid fuel cells. Without being bound to any theory, it is believed that embodiment(s) of the fuel cell electrode assembly substantially prevent the structure from cracking when subjected to heating, thereby advantageously substantially increasing its mechanical integrity. Further, embodiment(s) of the fuel cell electrode assembly include a plurality of fibers mixed throughout a catalyst layer. Advantages of the fibers include, but are not limited to, a reduction in electrical impedance of the electrode and the fuel cell and an increase in the efficiency of the fuel cell's current delivery.

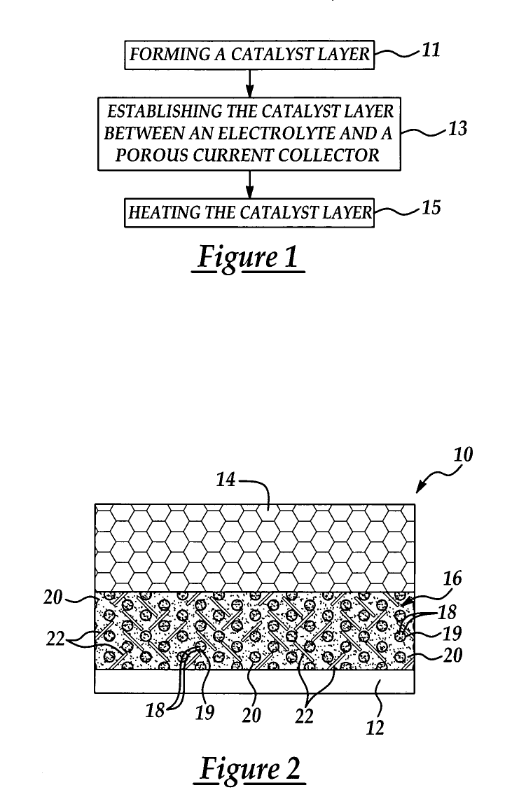

Referring now to FIG. 1, an embodiment of the method of forming an embodiment of the fuel cell electrode assembly is depicted. Generally, the method includes forming a catalyst layer, as shown at reference numeral 11; establishing the catalyst layer between an electrolyte and a porous diffusion layer, as shown at reference numeral 13; and heating the catalyst layer, as shown at reference numeral 15. It is to be understood that embodiment(s) of the method will be discussed in more detail hereinbelow in reference to the other Figures.

FIG. 2 depicts an embodiment of a fuel cell electrode assembly 10. Generally, the fuel cell electrode assembly 10 includes an electrolyte 12, a porous diffusion layer 14, and a catalyst layer 16 interposed between the electrolyte 12 and the porous diffusion layer 14. It is to be understood that the catalyst layer 16 is in electrochemical contact with the electrolyte 12 and with the porous diffusion layer 14.

The electrolyte 12 may be made of any suitable material. In an embodiment, the electrolyte 12 is a polymeric electrolyte, such as, for example, NAFION, which is commercially available from DuPont, located in Circleville, Ohio.

Other examples of suitable polymeric electrolytes include, but are not limited to sulfonated derivatives of a polymer that includes a lyotropic liquid crystalline polymer, such as a polybenzazole (PBZ) or polyaramid (PAR or KEVLAR which is commercially available from DuPont) polymers. Non-limitative examples of polybenzazole polymers include polybenzoxazole (PBO), polybenzothiazole (PBT) and polybenzimidazole (PBI) polymers. Examples of polyaramid polymers include, but are not limited to polypara-phenylene terephthalimide (PPTA) polymers.

The electrolyte 12 may also include a sulfonated derivative of a thermoplastic or thermoset aromatic polymer. Non-limitative examples of the aromatic polymers include polysulfones (non-limitative examples of which include polyethersulfone (PES), polyetherethersulfone (PEES), polyarylsulfone, polyarylethersulfone (PAS), polyphenylsulfone (PPSU) and polyphenylenesulfone (PPSO₂) polymers); polyimides (non-limitative examples of which include polyetherimide and fluorinated polyimides); polyphenylene oxides (PPO); polyphenylene sulfoxides (PPSO); polyphenylene sulfides (PPS); polyphenylene sulfide sulfones (PPS/SO₂); polyparaphenylenes (PPP); polyphenylquinoxalines (PPQ); polyarylketones (PK); polyetherketones (non-limitative examples of which include polyetheretherketone (PEEK), polyetherketone-ketone (PEKK), polyetheretherketoneketone (PEEKK) and polyetherketoneetherketone-ketone (PEKEKK)), and mixtures thereof.

It is to be understood that the electrolyte 12 may also include a sulfonated derivative of a non-aromatic polymer, such as a perfluorinated ionomer. Examples of suitable ionomers include, but are not limited to carboxylic, phosphonic, or sulfonic acid substituted perfluorinated vinyl ethers.

Still further, the polymeric electrolyte may include a sulfonated derivative of blended polymers, such as a blended polymer of PEKK and PEEK.

The electrolyte 12 may have a composite layer structure including two or more polymer layers. Non-limitative examples of composite layer structures are NAFION or PBI membranes coated with sulfonated polyetheretherketone (sPEEK) or sulphonated polyetheretherketone-ketone (sPEEKK). The polymer layers in a composite layer structure may be blended polymer layers, unblended polymer layers, and/or a combination thereof.

In an embodiment of the fuel cell electrode assembly 10 used in a direct methanol fuel cell, the electrolyte 12 may also optionally include a thin metal film (not shown) established therein. A non-limitative example of the thin metal film is palladium, which acts as a barrier to fuel (e.g. methanol in a direct methanol fuel cell) undesirably crossing over the electrolyte 12 to a cathode of the fuel cell electrode assembly 10.

In an embodiment, the electrolyte 12 ranges in thickness from about 1 μm to about 200 μm.

The embodiments of the fuel cell electrode assembly 10 shown in FIG. 2 includes a catalyst layer 16 interposed between the electrolyte 12 and the porous diffusion layer 14. In an embodiment, the catalyst layer 16 is a mixture of a catalyst 18 supported by a conducting high surface area structure 19, a polymeric electrolyte 20, and a plurality of fibers 22.

The catalyst 18 in the catalyst layer 16 is in electrical contact with an electrode (e.g. an anode or a cathode). It is to be understood that the catalyst 18 may be made of any material suitable for an anode or a cathode. Non-limitative examples of suitable anode catalyst materials include platinum, ruthenium, platinum ruthenium selenide, platinum ruthenium, iridium, osmium, molybdenum, tin, nickel, iron, alloys thereof, and mixtures thereof. A non-limitative example of a suitable cathode catalyst material includes platinum and its alloys. In a non-limitative example, a platinum or platinum ruthenium catalyst 18 is present in the catalyst layer 16 in an amount ranging between about 0.01 mg/cm² and about 10 mg/cm².

In an embodiment, the conducting high surface area structure 19 may be carbon particles, such as carbon black, which is commercially available under the tradename VULCAN XC-72 from Cabot Corp. located in Alpharetta, Ga.

In an embodiment, each of the plurality of fibers 22 is a high aspect ratio fiber. The high aspect ratio may range between about 10:1 (length to width) and about 1000:1 (length to width). Examples of suitable high aspect ratio fibers include, but are not limited to carbon fibers, carbon flakes, metal fibers (non-limitative examples of which include stainless steel, nickel, titanium, alloys thereof, and combinations thereof), and combinations thereof. Without being bound to any theory, it is believed that carbon fibers or flakes generally advantageously have substantial electrical conductivity and chemical inertness in a methanol environment.

In an embodiment, each of the plurality of fibers 22 may have an average diameter greater than about 100 nm. In a non-limitative example, the average fiber 22 diameter ranges between about 100 nm and about 10 μm, and an average length ranging between about 10 μm and about 1 mm.

Without being bound to any theory, it is believed that the plurality of fibers 22 in the catalyst layer 16 may substantially reduce electrical impedance between the catalyst 18 and the porous diffusion layer 14. This may be due in part to the fibers 22 carrying electrical current out to the diffusion layer 14 through intimate fiber 22 to fiber 22 contact, which forms a substantially linked conduction path. Further, the plurality of fibers 22 may advantageously increase the mechanical strength of the fuel cell electrode assembly 10.

It is to be understood that the catalyst 18 supported by the conducting high surface area structure 19 and the plurality of fibers 22 may be mixed throughout a polymeric electrolyte 20 to form the catalyst layer 16. The polymeric electrolyte 20 may be solubilized to achieve substantially thorough mixing. It is to be further understood that the polymeric electrolyte materials discussed hereinabove in reference to the electrolyte 12 may be used as the polymeric electrolyte 20 in the catalyst layer 16.

As previously indicated, in an embodiment of the method of forming the fuel cell electrode assembly 10, the catalyst layer 16 may be formed by mixing the catalyst 18 and the fibers 22 with the polymeric electrolyte 20.

The catalyst 18 supported by the structure(s) 19 and the plurality of fibers 22 may be substantially homogeneously or substantially heterogeneously mixed throughout the catalyst layer 16. Further, it is to be understood that areas of the catalyst layer 16 may have substantially homogeneously mixed catalyst 18 and/or fibers 22 while other areas of the catalyst layer 16 may have substantially heterogeneously mixed catalyst 18 and/or fibers 22.

Embodiment(s) of the method further include establishing the catalyst layer 16 on the electrolyte 12. This may be accomplished via any suitable deposition technique. Such deposition techniques include, but are not limited to, spin coating, screen printing, dip coating, meniscus coating, spray coating, painting, doctor blade printing, and combinations thereof. The catalyst layer 16 may be established at any suitable thickness. In an embodiment, the thickness of the catalyst layer 16 ranges between about 1 μm and about 1 mm. In another embodiment, the catalyst layer 16 ranges between about 10 μm and about 100 μm.

Embodiment(s) of the fuel cell electrode assembly 10 further include a porous diffusion layer 14 established on the catalyst layer 16. It is to be understood that the porous diffusion layer 14 collects current from the catalyst 18 in the catalyst layer 16 and conducts electrons that are exiting and entering the fuel cell electrode assembly 10. In a non-limitative embodiment, the porous diffusion layer 14 is at least one of carbon cloth, carbon paper, porous metal, metal mesh, and combinations thereof.

In an embodiment, the catalyst layer 16 is formed and established in situ between the porous diffusion layer 14 and the electrolyte 12. In an alternate embodiment, the catalyst layer 16 may be deposited on the porous diffusion layer 14, and the electrolyte 12 may then be deposited on the catalyst layer 16.

It is to be understood that the catalyst layer 16 may be established on the porous diffusion layer 14 by any suitable process. Non-limitative examples of suitable deposition processes include, but are not limited to spraying, brushing, printing, rolling, and the like, or combinations thereof.

After the porous diffusion layer is established on the catalyst layer 16, embodiment(s) of the method include heating the catalyst layer 16 (which may include subjecting at least a portion of the fuel cell electrode assembly 10 to heat). Heating advantageously results in substantially drying out the catalyst layer 16 and advantageously achieving bonding between the electrolyte 12 and the porous diffusion layer 14. It is to be understood that heating may be accomplished by any suitable method, including, but not limited to placing the assembly 10 between two heated plates. The temperatures for heating generally range between about 20° C. and about 250° C.

Without being bound to any theory, it is believed that the addition of the plurality of fibers 22 throughout the catalyst layer 16 advantageously substantially prevents deleterious cracking of the catalyst layer 16 during the heating process(es).

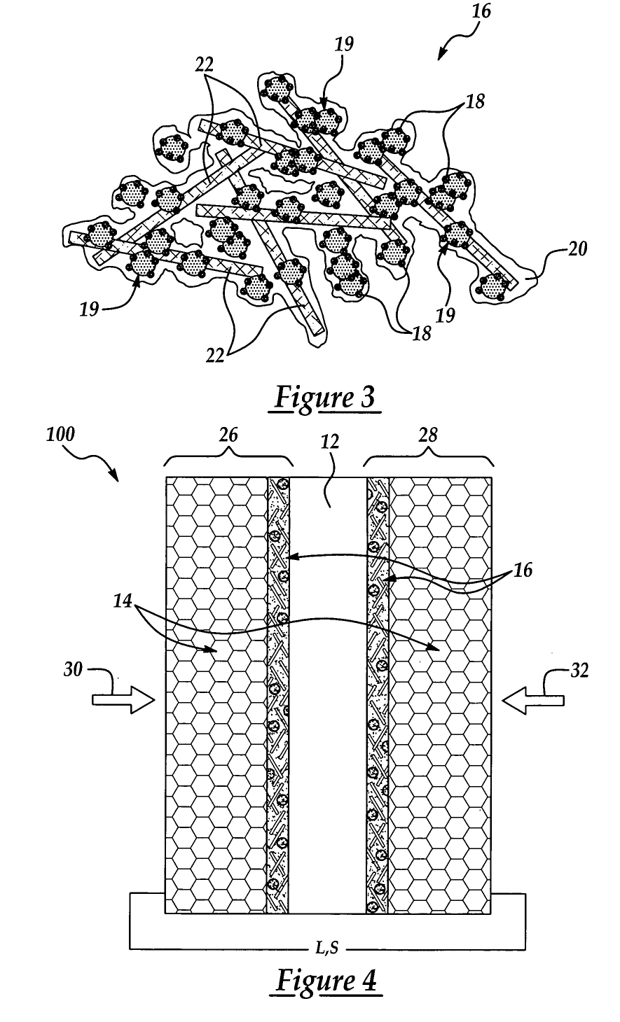

FIG. 3 illustrates an enlarged view of an embodiment of the catalyst layer 16. The plurality of fibers 22 and the catalyst 18 supported by the conducting high surface area structures 19 are interspersed with the polymeric electrolyte 20. In the embodiment illustrated in FIG. 3, the catalyst 18 may contact some or all of the plurality of fibers 22 (enlarged for illustrative purposes).

Referring now to FIG. 4, in an embodiment of the present disclosure, a fuel cell 100 includes at least one electrode 26, 28 in electrochemical contact with an electrolyte 12. It is to be understood that the electrode 26, 28 may be an anode 26 or a cathode 28. It is to be further understood that the electrodes 26, 28 of the fuel cell 100 may include embodiment(s) of the fuel cell electrode assembly 10 as disclosed herein. As such, embodiments of the electrodes 26, 28 may include a catalyst layer 16 and a porous diffusion layer 14.

FIG. 4 is a simplified schematic diagram of a single fuel cell membrane-electrode assembly (MEA) 100.

In an embodiment, MEA 100 may be one of Polymer Electrolyte Membrane (PEM) fuel cells, solid acid fuel cells, and Direct Methanol Fuel Cells (DMFC). Generally, liquid feed organic fuel cells, such as a DMFC, include the anode 26, the cathode 28 and a proton-conducting electrolyte membrane 12 positioned therebetween. The anode 26, cathode 28, and the electrolyte 12 may generally be a single multi-layer composite structure, as depicted. In the fuel cell 100 embodiments, oxidants 32 are carried to the cathode 28, and reactants 30 are carried to the anode 26.

In an embodiment, the reactants 30 are fuels, and the oxidants 32 are one of oxygen, air, and mixtures thereof. It is to be understood that any suitable fuel/reactant 30 may be used with the fuel cell 100. In an embodiment, the fuel/reactant 30 is selected from at least one of hydrogen, methane, ethane, propane, butane, pentane, methanol, ethanol, higher straight chain or mixed hydrocarbons, for example, natural gas or gasoline (low sulfur hydrocarbons may be desirable, e.g. low sulfur gasoline, low sulfur kerosene, low sulfur diesel), and mixtures thereof. Suitable fuels may be chosen for their suitability for internal direct reformation, suitable vapor pressure within the operating temperature range of interest, and like parameters.

An embodiment of a method of using fuel cell 100 includes the step of operatively connecting the fuel cell 100 to electrical load L and/or to electrical storage device S. The electrical load L may include many devices, including, but not limited to any or all of computers, portable electronic appliances (e.g. portable digital assistants (PDAs), portable power tools, etc.), and communication devices, portable or otherwise, both consumer and military. The electrical storage device S may include, as non-limitative examples, any or all of capacitors, batteries, and power conditioning devices. Some exemplary power conditioning devices include uninterruptible power supplies, DC/AC converters, DC voltage converters, voltage regulators, current limiters, etc.

It is also contemplated that the fuel cell 100 may, in some instances, be suitable for use in the transportation industry, e.g. to power automobiles, and in the utilities industry, e.g. within power plants.

Embodiments of the fuel cell electrode assembly 10 as disclosed herein offer many advantages, including the following. Without being bound to any theory, it is believed that embodiment(s) of the fuel cell electrode assembly 10 substantially prevent the structure from cracking when subjected to heating, thereby advantageously substantially increasing its mechanical integrity. Further, embodiment(s) of the fuel cell electrode assembly 10 include the plurality of fibers 22 mixed throughout an electrode 26, 28. Advantages of the fibers 22 include, but are not limited to, a reduction in electrical impedance of the electrode 26, 28 and an increase in the efficiency of the fuel cell's current delivery.

While several embodiments have been described in detail, it will be apparent to those skilled in the art that the disclosed embodiments may be modified. Therefore, the foregoing description is to be considered exemplary rather than limiting.

What is claimed is:

1. A fuel cell electrode assembly, comprising:
an electrolyte;
a porous diffusion layer; and
a catalyst layer interposed between the electrolyte and the diffusion layer, the catalyst layer including a mixture of at least one catalyst supported by a conducting high surface area structure, at least one polymeric electrolyte, and a plurality of fibers, each of the plurality of fibers having an average diameter greater than about 100 nm.

2. The fuel cell electrode assembly as defined in claim 1 wherein the electrolyte is a polymeric electrolyte.

3. The fuel cell electrode assembly as defined in claim 1 wherein the porous diffusion layer is at least one of carbon cloth, carbon paper, porous metals, metal mesh, and combinations thereof.

4. The fuel cell electrode assembly as defined in claim 1 wherein each of the plurality of fibers has a high aspect ratio ranging between about 10:1 and about 1000:1.

5. The fuel cell electrode assembly as defined in claim 1 wherein the plurality of fibers is at least one of carbon fibers, carbon flakes, metal fibers, and combinations thereof.

6. The fuel cell electrode assembly as defined in claim 1 wherein the at least one catalyst comprises at least one of platinum, ruthenium, platinum ruthenium selenide, platinum ruthenium, iridium, osmium, molybdenum, tin, nickel, iron, alloys thereof, and mixtures thereof.

7. The fuel cell electrode assembly as defined in claim 1 wherein the catalyst layer has a thickness ranging between about 1 micron and about 1 mm.

8. The fuel cell electrode assembly as defined in claim 1 wherein the catalyst layer has a thickness ranging between about 10 microns and about 100 microns.

9. The fuel cell electrode assembly as defined in claim 1 wherein each of the plurality of fibers has an average diameter ranging between about 100 nm and about 10 microns, and an average length ranging between about 10 microns and about 1 mm.

10. The fuel cell electrode assembly as defined in claim 1 wherein at least some of the at least one catalyst supported by the conducting high surface area structure are in contact with at least one of the plurality of fibers.

11. The fuel cell electrode assembly as defined in claim 1 wherein the conducting high surface area structure comprises carbon black.

12. A method of forming a fuel cell electrode assembly, the method comprising:
forming a catalyst layer, the catalyst layer including:
a polymeric electrolyte, the polymeric electrolyte capable of solubilizing;
a catalyst supported by a conducting high surface area structure; and
a plurality of fibers, each of the plurality of fibers having an average diameter greater than about 100 nm;
establishing the catalyst layer between an electrolyte and a porous diffusion layer; and
heating the catalyst layer, thereby bonding the electrolyte to the diffusion layer and forming the fuel cell electrode assembly.

13. The method as defined in claim 12 wherein forming the catalyst layer is accomplished by dispersing the catalyst and the plurality of fibers in the solubilized polymer electrolyte.

14. The method as defined in claim 13 wherein forming the catalyst layer is accomplished in situ.

15. The method as defined in claim 12 wherein the plurality of fibers is at least one of substantially homogeneously and substantially heterogeneously dispersed throughout the catalyst layer.

16. The method as defined in claim 12 wherein heating is accomplished at a temperature ranging between about 20° C. and about 250° C.

17. The method as defined in claim 12 wherein the thickness of the catalyst layer ranges between 10 microns and about 1 mm.

18. The method as defined in claim 12 wherein establishing the catalyst layer between the electrolyte and the porous diffusion layer is accomplished by depositing the catalyst layer on the electrolyte and positioning the porous diffusion layer on the catalyst layer.

19. The method as defined in claim 12 wherein establishing the catalyst layer between the electrolyte and the porous diffusion layer is accomplished by depositing the catalyst layer on the porous diffusion layer and positioning the electrolyte on the catalyst layer.

20. A fuel cell, comprising:
an electrolyte;
a porous diffusion layer; and
a catalyst layer in electrochemical contact with the electrolyte, and interposed between the electrolyte and the diffusion layer, the catalyst layer including a mixture of an electrode catalyst supported on a conducting high surface area structure, a polymeric electrolyte, and a plurality of fibers, wherein each of the plurality of fibers has an average diameter greater than about 100 nm.

21. The fuel cell as defined in claim 20 wherein the fuel cell is a direct methanol fuel cell.

22. The fuel cell as defined in claim 20 wherein the electrode catalyst is at least one of an anode material and a cathode material.

23. The fuel cell as defined in claim 22 wherein the electrode catalyst comprises at least one of platinum, ruthenium, platinum ruthenium selenide, platinum ruthenium, iridium, osmium, molybdenum, tin, nickel, iron, alloys thereof, and mixtures thereof.

24. The fuel cell as defined in claim 20 wherein the electrolyte is a polymeric electrolyte.

25. The fuel cell as defined in claim 20 wherein the porous diffusion layer is at least one of carbon cloth, carbon paper, porous metals, metal mesh, and combinations thereof.

26. The fuel cell as defined in claim 20 wherein each of the plurality of fibers has a high aspect ratio ranging between about 10:1 and about 1000:1.

27. The fuel cell as defined in claim 20 wherein the plurality of fibers is at least one of carbon fibers, carbon flakes, metal fibers, and combinations thereof.

28. The fuel cell as defined in claim 20 wherein the catalyst layer has a thickness ranging between about 1 micron and about 1 mm.

29. The fuel cell as defined in claim 20 wherein each of the plurality of fibers has an average diameter ranging between about 100 nm and about 10 microns, and an average length ranging between about 10 microns and about 1 mm.

30. An electronic device, comprising:
a load; and
the fuel cell of claim 20 connected to the load.

31. A method of using a fuel cell, comprising:
operatively connecting the fuel cell to a load, wherein the fuel cell comprises:
an electrolyte;
a porous diffusion layer; and
a catalyst layer in electrochemical contact with the electrolyte, and interposed between the electrolyte and the diffusion layer, the catalyst layer including a mixture of an electrode catalyst supported by a conducting high surface area structure, at least one polymeric electrolyte, and a plurality of fibers, each of the plurality of fibers having an average diameter greater than about 100 nm.

32. The method as defined in claim 31 wherein the electrode catalyst is at least one of an anode material and a cathode material.
